(19) United States
(12) Patent Application Publication
(10) Pub. No.: US 2020/0017744 A1
(43) Pub. Date: Jan. 16, 2020

(54) GLYCOL DEHYDRATING FURNACE COOLANTS

(71) Applicant: MacRae Technologies, Inc., Hayward, CA (US)

(72) Inventor: Allan J. MacRae, Hayward, CA (US)

(21) Appl. No.: 16/578,376

(22) Filed: Sep. 22, 2019

Related U.S. Application Data
(63) Continuation-in-part of application No. 16/449,464, filed on Jun. 24, 2019.

(51) Int. Cl. C09K 5/04; F27D 1/12

(52) U.S. Cl. CPC C09K 5/048; F27D 1/12

(57) ABSTRACT

An intrinsically safe pyrometallurgical furnace includes circulating a glycol dehydrating coolant. Substantially all the molecules of any initial weight of water it includes have been physically absorbed by a hygroscopic action into an initial weight of a glycol solvent. Substantially all the molecules of the initial weight of water included are suspended in solution between the molecules of a first portion of the initial weight of glycol solvent due to the hygroscopic action. A substantial remaining second portion of the initial weight of glycol solvent stays available to physically absorb any other water or steam that may later come in contact with the glycol dehydrating coolant as it circulates inside a desiccation containment vessel.

### FIELD OF INVENTION

The present invention relates to pyrometallurgical furnace coolants, and more particularly to glycol dehydrating coolants that bind up water such as to create an intrinsically safe environment safe from boiling liquid expanding vapor explosion (BLEVE).

The range of furnaces that can benefit from coolants of the present invention is extensive and includes those with vertically orientated stationary shells or those with binding systems such as Top Submerged Lance (TSL) furnaces, Electric Arc Furnaces (EAF), reverbatory furnaces, cyclone converter furnaces and smelter reduction furnaces, those with horizontally orientated or inclined shells such as Noranda Reactor or El Teniente Reactor, converters, or top blown rotary converter (TBRC). For non-ferrous bath smelting and converting such as TSL, Mitsubishi, and Vanyukov, and for flash smelting and converting such as Outokumpu and Inco. Also, EAF for smelting, settling, and converting non-ferrous oxide ores. For iron and steel making blast furnaces, cyclone converter furnaces and smelter reduction furnaces for direct to iron processes, basic oxygen furnaces (BOF), open hearth furnace, vacuum furnaces, fluidized bed and gasifiers, and EAF's. Cooling is used for furnace walls, roofs, shell openings or penetrations such as tapholes, inspection ports, burners ports, and doors, items inserted into the vessel such as tuyeres, burners, lances, inspection equipment, repair equipment, and downstream items such as launders and runners, and off-gas containment devices such as ducts. Furnaces can also be used in combination according to a unique smelting processes, wherein each furnace will have its own unique operating requirements.

### BACKGROUND

Modern pyrometallurgical furnaces must contain heat so intense that the refractory crucible must be forcefully liquid-cooled. In pyrometallurgical furnaces for iron making, very high temperatures are needed to melt iron ore and produce a high-carbon cast iron (pig iron). However, cooling furnace components with water as the coolant is very risky because of the possibility of steam explosions if ever any coolant leaks into contact the superheated interior.

Water is such a compelling and useful coolant that many risk using it, and so it is worthwhile to find a safe way to use it free of the risks of steam explosion, a kind of boiling liquid expanding vapor explosion (BLEVE). Water has a very high specific heat compared to other liquids and that makes water a top choice for use as a coolant. Water is also thin, non-viscous making it very easy to pump. It is also very stable and does not break down up until it converts to vapor.

Water can be an extremely explosive and dangerous material if it comes into contact with the super-heated baths inside pyrometallurgical furnaces. Water will flash to steam very forcefully in such contacts, and even small amounts can instantly destroy the furnace containment and the building around it. Steam explosions have caused many deaths and injuries. So the introduction in pyrometallurgical furnace applications of any water-based coolants into the cooling jackets of oxygen injecting lances and tuyeres, burner blocks, bath containment cooler panels, and launders, all run the risk of this kind of BLEVE.

The conventional prevention of steam explosions in boilers mainly involves pressure relief valves that vent steam if the pressures inside a boiler come close the the maximum pressure capacity of the boiler itself.

The prevention of steam explosions in furnaces must be handled very differently. Water, used as coolant, must be prevented from leaking or spilling into the hot liquid melt inside the furnace where any contact will instantly flash into steam. One obvious way to do this is to never employ water. If water is employed as a coolant, the coolant pipes and passageways must never crack or leak. However, the permanent elimination of all cracks and leaks is neither realistic nor practical to achieve.

Jun. 3, 2019, Mark William Kennedy (mark.william.kennedy@elkem.no) There is some explosion risk, which can be quantified in empirical studies of the alloy involved. Two-phase oils advantageously boil in a thermal crisis, and that improves heat transfer by an order of magnitude before Critical Heat Flux (CHF) is reached, then the cooler transitions to film boiling and subsequent failure.

This is at the ‘cost’ of some risk of a Boiling Liquid Expanding Vapor Explosion (BLEVE). As a rule, there is no one perfect coolant with low cost, no toxicity, flammability or explosivity. In practice, selecting a coolant is an exercise in risk management. Wendell Hull & Associates, Inc., USA tested the flammability of various MEG:water combinations and concluded that it is a characteristic of ethylene glycol coolant to be essentially non-combustible when mixed with small quantities of water. This is in contrast to pure ethylene glycol, which boils at around 177° C., has an auto-ignition temperature of around 399° C., and a flash point of around 127° C. The ratio of water to ethylene glycol recommended by coolant manufacturers ranges from 50:50 to 30:70, with cautions not to exceed 30:70.

What is needed for better prevention of steam explosions in pyrometallurgical furnaces is using a coolant that will not instantly flash into steam if it leaks or spills into the hot liquid melt either inside the furnace, or in a conduit for the transfer of molten materials such as launders and throughs. But such coolant needs to perform as well, or better, as pure water in every other regard.

Any change in explosivity is not known at present and should be investigated by any potential user using their own alloy. In general, one working theory is that the ‘poorer’ the heat transfer properties of the fluid, the safer will be the risk of BLEVE. A reduced rate of heat transfer limits the peak heat flux. The oils that crack when injected into liquid metal make for a large heat sink into the cracking. Such further reduces the peak over pressure and explosive damage potential.

The magnitude of the peak pressure spikes corresponds to the explosive damage potential, not the area integrated under a pressure-time curve. Weaponization tests conducted by the Canadian military provided some background. See, A REVIEW OF LARGE SCALE AND SMALL SCALE UNDERWATER THERMAL EXPLOSIONS, by M. Rizk, April 1990. (See page 85 of the attached reference with regards to over pressure peak and pressure wave speed.) Both over pressure and speed can be directly related to the ‘bomb damage’.

Overall explosivity is probably a function of both the metal and fluid heat transfer properties. Aluminum is more “explosive” than steel, not due to chemical effects, but due to its much greater heat transfer properties. Similarly, water will be much more dangerous than a thermal oil with reduced heat transfer properties. It is not possible at present to state if “80/20” glycol water is twice as safe or ten times as safe as water. Empirical data are required under realistic conditions.

The explosivity of water has been well demonstrated, limited explosion testing has been conducted with coolants like ISIS-B, MEG and Galden HT200. Larger scale tests conducted with quantities and conditions simulating realistic cooler failure scenarios would be very informative. Proactive furnace owners should perform such tests to implement the use of alternative coolants around tap-holes, and other high-risk furnace areas.

### SUMMARY

Briefly, a coolant embodiment of the present invention for use in support of a pyrometallurgical furnace includes circulating a glycol dehydrating coolant. Substantially all the molecules of any initial weight of water included in the solution are exceeded by and physically absorbed by less than all the molecules of any initial weight of glycol solvent. The molecules of water automatically suspend in solution physically between the molecules of the glycol solvent. Any later introduced water or moisture is desiccated immediately due to the hygroscopic action. A substantial portion of the initial weight of glycol solvent remains available to physically absorb any other water or steam that may later come in contact with the glycol dehydrating coolant as it circulates inside a desiccation containment vessel.

### SUMMARY OF THE DRAWINGS

FIG. 1 is a functional block diagram in a schematic type view of a cooling system embodiment of the present invention that is intrinsically safe from steam explosions should any of its liquid, water-based coolant escape or leak into a pyrometallurgical furnace. The coolant is protected from external sources of water contamination from the environment by piping and a pressurized desiccation containment vessel;

FIG. 2A is a schematic view of a particular type of top submerged lance furnace (TSL) with liquid cooling that has been improved for use in a gas injection system embodiment of the present invention;

FIG. 2B is a schematic view of a particular type of iron pyrometallurgical furnace with liquid cooling that has been improved in a system embodiment of the present invention;

FIG. 3 is a cross-sectional diagram of a top submerged lance (TSL) embodiment of the present invention that circulates a heat transfer fluid that is intrinsically safe from BLEVE as part of the cooling system of FIG. 1;

FIG. 4 is a functional block diagram of a typical stave cooler in a pyrometallurgical furnace and supporting external cooling plant that filters, pumps, pressurizes, dumps heat, and protects a circulating intrinsically safe coolant from external moisture with a desiccant containment; and

FIG. 5 is an exploded assembly view diagram of a stave cooler embodiment of the present invention that could be usefully and advantageously employed as the stave cooler in the pyrometallurgical furnace of FIG. 4.

### DETAILED DESCRIPTION OF THE EMBODIMENTS

Diffusion alone can provide the driving force required to cause the spontaneous formation of a solution. In some cases, however, the relative magnitudes of intermolecular forces of attraction between solute and solvent species may prevent dissolution. Three types of intermolecular attractive forces are relevant to the dissolution process: solute-solute, solvent-solvent, and solute-solvent. The formation of a solution may be viewed as a stepwise process in which energy is consumed to overcome solute-solute and solvent-solvent attractions (endothermic processes) and released when solute-solvent attractions are established (an exothermic process referred to as solvation). The relative magnitudes of the energy changes associated with these stepwise processes determine whether the dissolution process overall will release or absorb energy. In some cases, solutions do not form because the energy required to separate solute and solvent species is so much greater than the energy released by solvation.

Hydrogen bonding is the dominant intermolecular attractive force present in liquid water. A mixture of ethanol and water will mix in any proportions to yield a solution, both substances are capable of hydrogen bonding, and so the solvation process is sufficiently exothermic to compensate for the endothermic separations of solute and solvent molecules.

A solution forms when two or more substances combine physically to yield a mixture that is homogeneous at the molecular level. The solvent is the most concentrated component and determines the physical state of the solution. The solutes are the other components typically present at concentrations less than that of the solvent. Solutions may form endothermically or exothermically, depending upon the relative magnitudes of solute and solvent intermolecular attractive forces. Ideal solutions form with no appreciable change in energy.

Embodiments of the present invention are based on a glycol dehydrating coolant comprising a homogenous solution of a water solute in a glycol solvent, and in which the number of water molecules is initiated and maintained to be substantially less than the initial number of glycol alcohol molecules. (For a safety margin.) Every solute water molecule must be physically suspended between molecules of the alcohol glycol solvent. Such molecules can only attach to each other one-to-one. This occurs naturally in an exothermic solvation process, wherein disorder and entropy are increased. But only if the number of water molecules total is always maintained to be substantially less than the initial number of glycol alcohol molecules, e.g., to guarantee every molecule of water will be bound up and not directly free to steam explode.

But real applications of embodiments of the present invention are not so simple. Corrosion inhibitors must be always included, Such vary typically from 4% to 8% by weight of the fluid and the initial proportions must not deny a molecule of glycol for every molecule of water. Typical corrosion inhibitors have a density of 1390±200 grams per liter.

In chemistry, an alcohol is any organic compound in which the hydroxyl functional group is bound to a carbon. Alcohols useful as solvent 108 include various glycols seen in industry: triethylene glycol (TEG), diethylene glycol(DEG), ethylene glycol (MEG), and tetra-ethylene glycol (TREG). Their respective molecular weights are MEG: 62.1, DEG: 106.1, TEG: 150.2, and TREG: 194.2, with proportional increases in boiling point and viscosity. MEG is preferred here.

MEG is an organic compound with the formula (CH₂OH)₂. It is mainly used in the manufacture of polyester fibers and for antifreeze formulations. It is an odorless, colorless, sweet-tasting, viscous liquid. Ethylene glycol is toxic.
MEG Molar mass: 62.07 g/mol
Formula: C₂H₆O₂
Boiling point: 387.7° F. (197.6° C.)
Melting point: 8.78° F. (−12.9° C.)
Density: 1.11 g/cm³ at 20° C.
IUPAC ID: Ethane-1,2-diol

Water has a molar mass of 18.02 grams per mole, a density of 0.998 grams per cubic centimeter (g/cm³) at 20° C.

A mole of water in a mole of ethylene glycol (MEG) is the maximum that will allow every molecule of water to attach one-to-one with a molecule of MEG. One mole of water weighs about 18.02 grams, and one mole of MEG weighs about 62.07 grams. That means a ratio of 1:3.44 at 20° C., by weight, or 27.5%-Wt of solution (at maximum) can be water. A liter of pure water weighs 998 grams, and a liter of MEG weighs 1115 grams. (A liter of water has 55.3 moles of water, a liter of MEG has 18.0 moles of MEG.)

The weight percent of water in the combined fluid is about 22.5%-Wt without corrosion inhibitors, and about 22%-Wt and 21%-Wt with 4% and 8% corrosion inhibitors, respectively. Water in excess of this means there will be some molecules of water that are not hydrogen-bound to a molecule of MEG. (Other glycols and alcohols vary in molar weight.) Excess MEG will burn, not explode. Excess water can flash to steam.

A margin, perhaps 20%, should be maintained to allow for variations in corrosion inhibitors, meaning each liter of MEG solvent should be initiated to have no more that 0.20 liter of water solute. The glycol dehydrating coolant is therefore preferably initiated herein at 25.1%-Wt maximum to 17.6%-Wt minimum water by weight (Wt %) maximum. Less water is permissible, but less water makes the coolant more viscous, harder to pump, and less efficient at picking up and dumping heat. The Wt % will vary with the ambient temperatures of the fluids, hence, density must be accounted for. More water is to be avoided since water molecules not bound by glycol molecules start to appear in the blend.

Less water reduces the performance because the specific heat of the solution is lessened. Far less water than that increases the viscosity of the solution too much and works the circulation pump harder (or too hard). This is important, because at startup temperatures, e.g., at 20° C. where 80%-Vol (18.2%-Wt) MEG viscosity is 6.1 mPa/sec, but 90%-Vol MEG viscosity is 13.0 mPa/sec, and could be too stiff for a particular pump to spin up. Motors with higher starting torques come at a price.

At 20° C. (293° K), the thermal conductivity of 80%-Vol MEG is about 0.28 W/mK, and this can be improved to 0.31 W/mK for 70%-Vol MEG. Pure water at 20° C. has a thermal conductivity of 0.60 W/mK. But less than all the water molecules will have a hydrogen bond with a MEG molecule. They will nevertheless be suspended in the homogeneous solution and buffered away from instantly being able to join in a steam explosion.

Steam explosions can be reduced in strength by consuming energy at the wave front and turning it into something other than heat, and by slowing down the propagation with tiny delays.

There is no hard threshold where the reduced risks of steam explosion are precipitously lost, except of course all benefit is lost when the MEG is reduced to 0%. The preferred embodiment is thus to initiate glycol dehydrating coolant to an equivalent at 20° C. at about 18%-Wt to 25%-Wt water. The wisdom and safety in using a higher initial percentage of water by volume will have to be determined from empirical evidence.

A principal characteristic of this glycol dehydrating coolant is that there will be complete hydrogen bonding of all of the water molecules, and a matching number of glycol alcohol molecules. Such ratio will stumble and impede the development of steam explosions should a part of the glycol dehydrating coolant contact any superheated material in a pyrometallurgical furnace.

The glycol dehydrating coolant is maintained in a desiccant containment vessel that keeps it under pressure to raise its boiling point, and to isolate it, and prevent it from absorbing environmental moisture. At 20%-Wt water, the boiling temperature of the glycol dehydrating coolant is about 120° C. at 0.96 Bar. The vapor pressure at 149° F. is about 2.89 bar. (The freeze points are essentially irrelevant in furnace applications.)

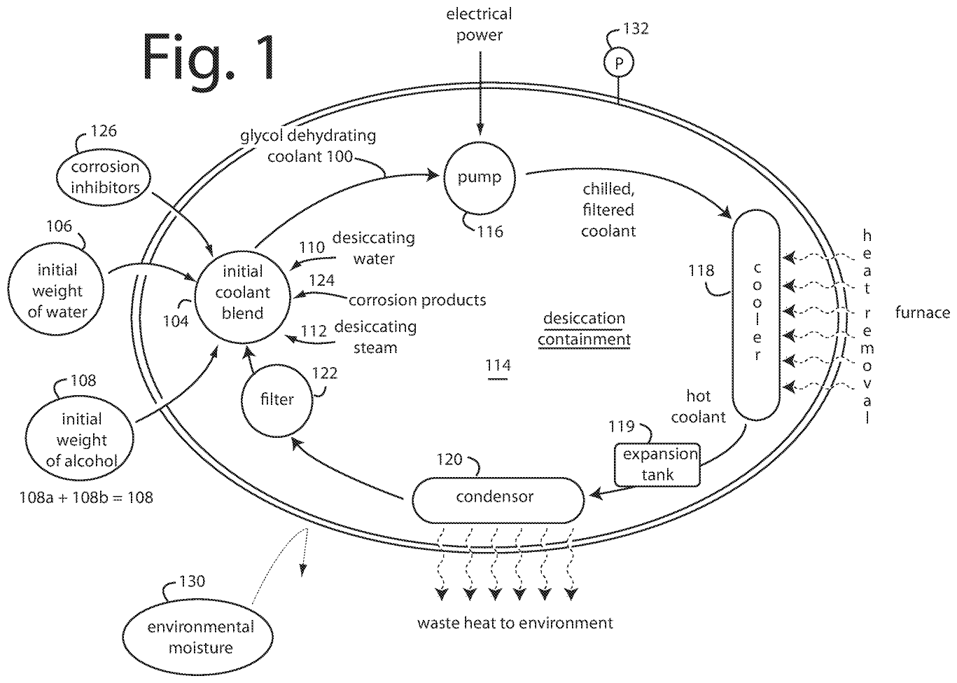

FIG. 1 represents the use of a glycol dehydrating glycol dehydrating coolant 100 in a pyrometallurgical furnace 102. E.g., a pyrometallurgical furnace. An initial coolant blend 104 circulates in which substantially all the molecules of any initial weight of water solute 106 it includes have been physically absorbed by a hygroscopic action into an initial weight of glycol solvent 108. Substantially all the molecules of the initial weight of water solute 106 included are physically suspended in solution between the molecules of a first portion 108a of the initial weight of glycol solvent. Hydrogen bonds form between the two types of molecules. The glycol solvent 108 will at all times remain unsaturated because the water solute and glycol solvent are completely miscible with each other.

Every molecule of all the water must have available an excess of molecules of glycol that it can make a hydrogen bond with. Such hydrogen bonding is what principally impedes steam explosions on the molecular level in the embodiments of the present invention.

A substantial, remaining second portion 108b of the initial weight of glycol solvent 108 stays available in reserve to physically absorb any other water 110 or steam 112 that may later come in contact with the coolant blend 104 as it is pumped to circulate inside a desiccation containment vessel 114.

Molecules of separated water solute 110 and separated water steam 112 may have originally been included in the initial weight of water solute 106, and were separated by heat from their individual hygroscopic bindings with glycol solvent 108. A water desiccating characteristic action of glycol dehydrating coolant 100 will grab any water back immediately, temperature permitting. Such recombination may occur in the condensor 120 where waste heat is dumped or otherwise exhausted.

Molecules of separated water solute 110 and separated water steam 112 may have also been sourced from residue moisture inside any component or through a leak or crack. The advantage here is such water is immediately bound up on contact with glycol dehydrating coolant 100 because of its inherent desiccating action.

The desiccation containment vessel 114 excludes and protect the glycol dehydrating coolant 100 from contamination with water by any external ambient environmental moisture 130.

A pump 116 that operates on electrical power forces the circulation of the glycol dehydrating coolant 100 through an evaporative cooler 118, a hot expansion tank 119, a condensor 120, a cool expansion tank, and a particulate filter 122. Pump 116 is load-sensitive to the viscosity of glycol dehydrating coolant 100, and must provide sufficient volume and velocity of glycol dehydrating coolant 100 through cooler 118 to maintain adequate cooling and protection of the pyrometallurgical furnace 102. Such viscosity will be at maximum before pump 116 starts up and glycol dehydrating coolant 100 has been allowed to drop back to room temperatures.

Pump 116 must therefore be of sufficient size given these maximum viscosity, minimum volume, and minimum velocity requirements. A sizing in excess of this would be wasteful and expensive.

Expansion tank 119 is necessary to accommodate the typical enlargement of glycol with heat. The working pressures however, should remain relatively constant.

The suspension of all water molecules 106, 110, and 112 between less than all the glycol solvent molecules 108a prevents or substantially reduces the glycol dehydrating coolant desiccating glycol dehydrating coolant 100 from producing a steam explosion in the event any of it directly contacts any superheated materials within the pyrometallurgical furnace 102.

A principal purpose of filter 122 is to remove any solid products of corrosion 124. It is therefore preferred to initially add conventional corrosion inhibitors 126 that will not substantially interfere with the heat removal from furnace 102 by cooler 118.

The desiccation containment vessel 114 keeps glycol dehydrating coolant 100 under pressure and isolates it from environmental moisture 130. Uncontrolled, such environmental moisture 130 can eventually ruin any desiccating abilities of glycol dehydrating coolant 100.

A pressure safety release 132 maintains a safe pressure inside desiccation containment vessel 114. Pressurizing glycol dehydrating coolant 100 will raise its boiling point and help counter any tendency for film boiling inside cooler 118.

If a leak were to develop in which coolant was escaping, it may not be advantageous to have the coolant under pressure.

Glycol dehydrating coolant 100 should be monitored, tested, and replaced periodically for how much water solute 106, 110, and 112 and corrosion products 124 it has absorbed in service. The weight of such water solute 106, 110, and 112 should never exceed the weight of alcohol 108, nor come within a predetermined safety margin, such as 10%.

Steam explosions result from the violent boiling and flashing of water into large volumes of steam. Such can occur when water is superheated by sudden contact with molten metals. Liquid water instantly changes phase to a gas, with an explosive pulse of great pressure, and that dramatically increases its volume. Unfettered, the explosive pressures can rip open pressure vessels, containment shells, and destroy whole pyrometallurgical furnaces and the buildings they're in.

Most normally, steam explosions are not chemical explosions, although a number of substances will quickly react chemically with steam. For example, zirconium and steam reactions produce hydrogen, as does superheated graphite and air. The free hydrogen can then burn violently in chemical explosions and fires that follow.

Some steam explosions appear to be special kinds of boiling liquid expanding vapor explosion (BLEVE), and produce a release of stored superheat. Foundry accidents, show evidence of an energy-release front that propagates through the material and creates fragments that mix the hot phase into the cold volatile phase. The rapid heat transfer at the front sustains the propagation.

Embodiments of the present invention interfere with the rapid flashing of liquid water into steam by hygroscopic physical absorption of all the water into a 100% miscible solvent like organic alcohol. The water molecules are suspended between the solvent's molecules in the process. The water will eventually expand into steam, but the process is hindered enough to hobble any explosion.

Embodiments of the present invention render water used as a coolant in a furnace intrinsically safe from boiling liquid expanding vapor explosions (BLEVE) by binding up a limited amount of water into a glycol dehydrating coolant. What compels the use of water at all is water's superior thermal transfer efficiencies, cheap cost, and thin viscosity. In very severe furnace cooling applications, these beneficial traits are universally pressed very hard.

Conventional coolants are usually aqueous solutions of water with glycol added to benefit from the extended freezing and boiling points of the solution. The pyrometallurgical furnace coolants of the present invention are alcohol solutions of glycol dehydrating coolant to benefit from the solution's desiccant properties.

Water desiccation systems based on glycol dehydration feed lean, water-free glycol (purity>99%) into the top of an absorber, or “glycol contactor”, where it will contact a wet gas or liquid stream. The glycol removes water from the stream by physical absorption and is carried out the bottom of a column. The glycol stream exiting the absorber is a so-called “glycol dehydrating coolant”.

Embodiments of the present invention circulate glycol dehydrating coolant as a high efficiency coolant through pyrometallurgical furnace coolers, lances, tuyeres, and other appliances. The water that has been physically absorbed by the lean, water-free glycol enhances the specific heat and improves viscosity over pure glycol alone. The limit of how much water can be added-in is equal to how much water can be physically absorbed by the lean, water-free glycol. Free water not physically absorbed can feed into a BLEVE. The minimum amount of water that should be added to the lean, water-free glycol to produce a glycol dehydrating coolant for a pyrometallurgical furnace cooler is controlled by a minimum specific heat and a maximum viscosity of the glycol dehydrating coolant that can be tolerated by the heat loads demanded and the costs of adequate coolant pumps.

It would of course be prudent to set and observe customary operational margins in the glycol dehydrating coolant constituency balance.

An advantage is that any free water that appears in the coolant system is immediately desiccated and absorbed by the glycol dehydrating coolant. Of course if the glycol dehydrating coolant constituency balance has margin to do so. Portions of the glycol dehydrating coolant that have been heated excessively will regenerate a small amount of the lean glycol and free its absorbed water. Such process takes work and time and therefore can dampen a local small BLEVE. Any lean enough glycol in the immediate vicinity will immediately re-absorb the freed water.

Several major heat transfer fluid cooled components conventionally used in and around pyrometallurgical furnaces run the risk of significant leaks either onto the top of the bath submerged or injected into the bath. For example, water-cooled vertical lances, like subsonic Top Submerged Lance (TSL) in nonferrous furnaces, sonic lances used for steel making in Basic Oxygen furnaces. Also, furnace walls, roof cooling blocks, tap hole blocks, torches, launders, tuyeres, burner blocks, burners, etc. for both ferrous and non-ferrous furnaces.

If there is a coolant leak onto the top of a bath, a crust of slag there can freeze. Then once the frozen slag cracks, free water can flow in to reach the matte or metal below and cause a a steam explosion type BLEVE.

If a metal body in a cooler is worn away enough for an internal pipe to be exposed, such could also leak cooling fluid into the furnace.

If any superheated metal contacts a block itself, it could thermally overload the cooling block's capacity to remove the heat, and that could lead to internal steam generation and the catastrophic failure of the cooling block. Steam inside the coolant passages significantly interferes with the ability of the block to remove heat because it introduces excess levels of thermal resistance to the liquid and pressure pulses in the cooling system. Such then can lead to melting and rapid block wear, and end with a fluid leak into the furnace. This can also occur in contacts with superheated slag or matte, but the risk is often less than with liquid metal itself.

If there is a large leak of molten slag, metal or matte out of the furnace and if it contacts a cooling fluid line, an explosion outside of the furnace could occur with water.

TSL furnaces are used for non-ferrous production, and have submerged lances to sub-sonically inject oxygen enriched air to burn the sulfur fuel available in the ore. TSL furnaces are charged with concentrate for smelting, or matte for converting. The TSL is a chemical reactor with a relatively short residence time, on the order of about fifteen minutes. Closely taken measurements and sampling of the feed and oxygen reagents are critical.

BOF furnaces are used for ferrous production, and have non-submerged lances above the bath that super-sonically inject oxygen to burn carbon-based fuels in the bath. BOF furnaces are fed with scrap iron, or pig iron, and the fuel.

The ore from mines must usually be concentrated before it can be smelted for its metals. In copper smelting, those ores are primarily chalcopyrite (CuFeS₂), or other sulfides of copper and iron minerals. These are crushed and ground to release the target minerals from the “gangue” waste minerals. The powdered ore can then be more easily concentrated with mineral flotation techniques.

The concentrates are input as a feed material for smelting in furnaces to produce a “matte”. Matte is a molten mixture of sulphides. And “slag” is a molten mixture of oxides and any unreduced sulphides. Copper matte can be readily converted and refined into anode copper. A copper matte is an intermediate product, e.g., in the extraction of copper from sulphide ores that naturally contain copper. Furnaces are used to treat many different feed materials, which are concentrates derived from ore, secondary products from smelting or converting, scrap, slimes or residues from metal refining, or waste. Metals treated are copper, nickel, zinc, aluminum, lead, tin, gold, platinum-group metals (PGMs).

The matte produced will vary in “grade” depending on how the furnace is being operated. For copper, the matte grade as we use it here means, and is defined as,

$$Cu grade = \frac{Amount of Cu in matte}{Amount of {Cu}_{2} S + FeS} \times 100.$$

One of the furnace types we are concerned with herein employ a steel lance that is lowered into the bath from above, and air, or oxygen-oxygen enriched air, is forcefully injected through the lance at subsonic speeds into the bath to agitate and oxygenate the bath. Feed to the furnace consists of one or more of mineral concentrates, matte, metal, flux, coal, coke, oil, natural gas, reverts, or recycled materials, which are dropped either through a roof opening into the bath, or fed down the lance.

Some lances employ “swirlers” to spin the injection gas within the lance to promote mixing of the oxygen and fuel at the discharge end.

Movement of air and oxygen down the lance helps to cool the steel. Such cooling can help to freeze a layer of slag in a protective coating outside the lance. Layers of solid slag help protect the lance from wear and the high temperatures inside the furnace bath. TSL furnaces operate up to 1400° C.

The submerged tips of lances will eventually wear out. And lances that have not been cooled well enough and allowed to heat unevenly can also develop pronounced curves along their relatively long lengths. The lances 202 can also develop holes or cracks on the side which can lead to the leakage of the oxygen enriched air or oxygen to the sides and walls, thereby increase refractory wear and splash.

Refractory bricks are used as an internal lining in the furnace to protect its steel shell from the heat inside. A lance that has curved too much will cause increased damage to the refractory from erosion or impingement when the injected gases, generated process gases, and agitation become too intense in the near wall region.

The metal, matte and slag smelting products are removed from furnaces through “tap holes” or outlets, either continuously or in batches. Fume to be collected and process gases exit via an opening in the roof to the off-gas system.

Furnaces that run with the lance immersed are subject to high amounts of wear to their tips. Such wear will eventually require the lance to be replaced after as little as a day, or as much as a week or two of nearly continuous operation.

Lance immersion depths are normally controlled based on a measured amount of tip pressure. Operators also closely monitor the matte grade and bath temperatures. If the matte grade is too high, there is a risk of the bath foaming, and downstream processing in the converters will be more difficult. If the matte grade is too low, refractory wear will increase, especially downstream in the launders.

Refractory linings for nonferrous smelting and converting are most often constructed using high MgO bearing materials, which are subject to hydration via the formation of Brucite after contact with water. The elimination of water in any heat transfer fluids has this as a second benefit, in addition to the avoidance of BLEVE.

Lances for top submerged lance (TSL) furnaces conventionally have a carbonaceous fuel pumped down the center and discharged into the furnace that adds to the sulfur fuel in the ore. The most common fuels are oil and natural gas. Hence, using hydrocarbons in any heat transfer fluid would not present a new risk to the operation of such a furnace.

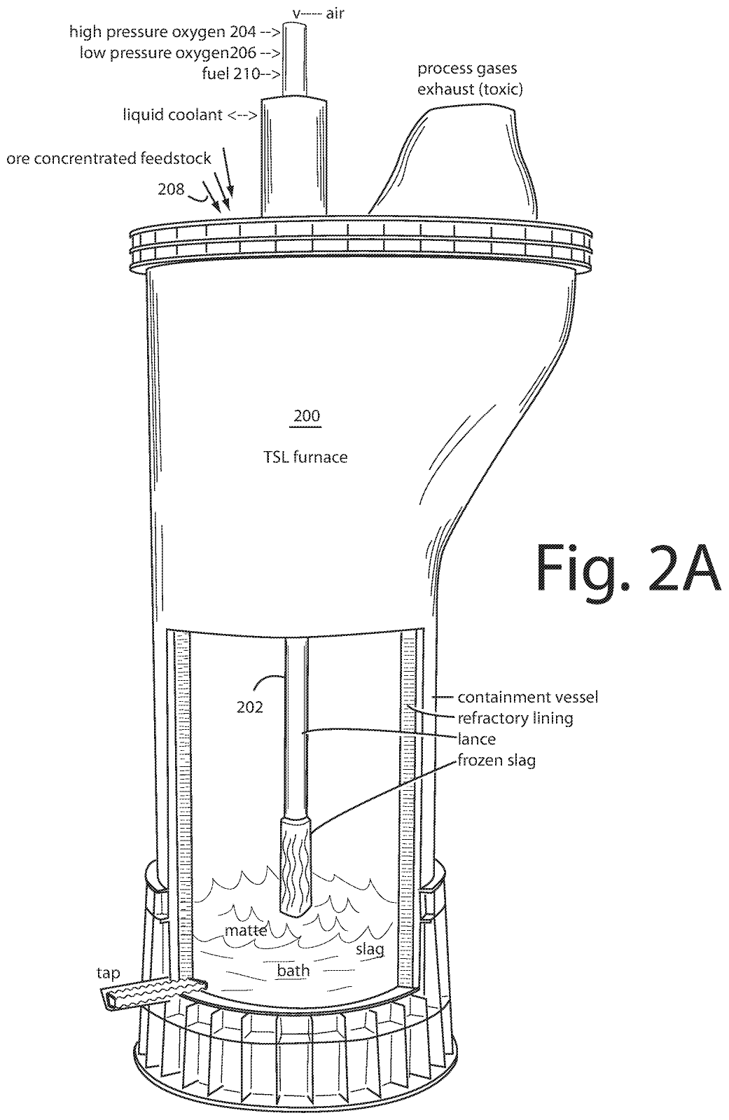

FIG. 2 represents an ISASMELT-type furnace 200 as a kind of TSL vessel with an improved liquid cooled lance embodiment of the present invention, herein referred to by the general reference numeral 202.

Most of the energy needed here to heat and melt feed materials like chalcopyrite (CuFeS₂), and other sulfide of copper and iron minerals, is derived from a reaction of oxygen 204 and 206 forced down inside lance 202, with the sulfur in a feed ore concentrate 208 being the main “fuel”. A supplemental energy fuel 210, like coal, coke, petroleum coke, oil, natural gas, and other non-solid fuels are sometimes needed and are injected down inside lance 202 to make up for any fuel deficiencies. Solid, supplemental fuels are also sometimes added through the top of furnace 200, e.g., in with the feed ore concentrate 208.

TSL vessels 200 that run with an immersed lance 202 universally experience high wear to their distal end tips. Some tips may even simply burn off if not cooled well enough. So conventional lances are often constructed with replaceable tips to keep maintenance costs down. Other types of oxygen lances, like in basic oxygen furnaces (BOF), are run with their tips several hundred millimeters above the surface and inject a supersonic jet of oxygen and fuel. This jet has enough force to punch through the surface of the melt.

The optimum depth to operate lance 202 is normally maintained with controls based on the tip gas pressure or level sensors. Operators must also monitor the matte grade and bath temperature. Too high, and there is a risk of the bath foaming, and downstream processing in the converters will be more difficult. Too low, and refractory wear will increase, in particular downstream in the launders.

TSL 202 has a protective liquid cooled jacket that extends its full length to a tip. The protective liquid cooled jacket receives the glycol dehydrating coolant 100 from a cooling system. The cooling here of TSL 202 will stop any tendency of thermal curving by precluding uneven heating during operation. To do that, the liquid cooled jacket may include swirlers and restrictors, flows that maintain a minimum velocity flow at critical points to prevent film boiling. TSL 202 has as its basic purpose to provide for the injection of an oxygen flow into a pyrometallurgical furnace 200.

Glycol dehydrating coolant 100 has a preferred predetermined viscosity less than 20 mPa·s, and a predetermined specific heat greater than 2.3 kJ/kg.K. These two limits allow economical choices to be made for pump 116.

Mechanisms for swirling heat transfer fluids and for making tip replacements possible for lances are conventional and plentiful, and are therefore not necessary to describe in particular detail here. Both would of course enhance and improve most embodiments of the present invention.

FIG. 2B represents a pyrometallurgical furnace type of pyrometallurgical furnace 230 with a roof 232, a stack 234, a belly 236, a bosch 238, a tuyere level 240, and a hearth 242. Cast iron stave coolers 244 will provide good service in the upper stack 234 because heat flux doesn't generally exceed 25 kW/m². Special high heat flux cast copper coolers 246 are required below in the lower stack 234, belly 236, bosch 238, tuyer level 240, and hearth 242 because heat flux will generally far exceed 25 kW/m². Particular high heat flux cast copper coolers 246 here can receive 2-4 times the heat loads, and therefore require 2-4 times the coolant flows their comrades do.

The intrinsically coolants of the present invention are used in furnace 230 to prevent/avoid steam explosions.

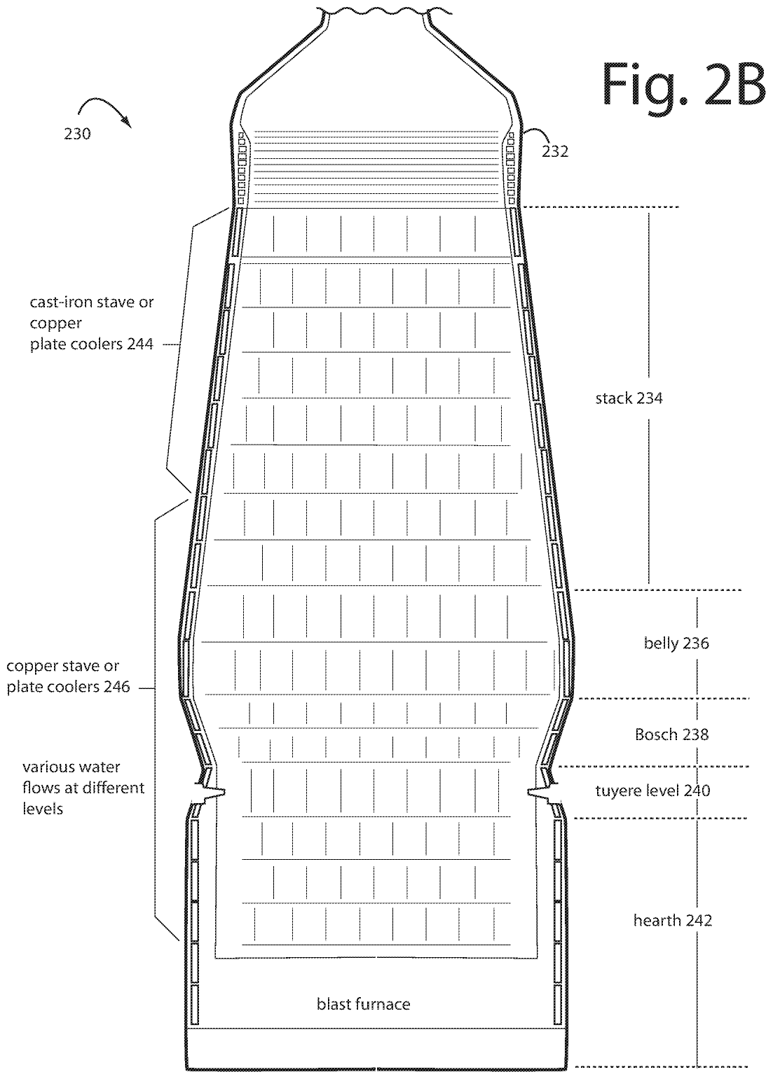

FIG. 3 represents a type of an oxygen/oxygen enriched air injection lance, a top submerged lance (TSL) 300 in an embodiment of the present invention. Such has an outer cooling jacket equivalent to cooler 118 in FIG. 1. TSL 300 injects a fuel supply 302 down a central conduit 304 to a copper lance tip 306. An oxygen enriched air is fed into manifold 310. This pipes the air to a jacket 312 that coaxially encases fuel conduit 304. The fuel joins and mixes with the oxygen rushing out the copper TSL tip 306 below.

Still two more outer coaxial conduits 316 and 318 are positioned to fully jacket inner conduits 304 and 312. The two outer coaxial conduits 316 and 318 are extensions of the desiccant containment vessel 114 (FIG. 1). They must exclude environmental moisture 130, and must maintain the working coolant pressure set by pressure safety valve 132. Any water 110 or steam 112 spontaneously appearing inside the two outer coaxial conduits 316 and 318 are immediately desiccated and captured by coolant blend 104 in glycol dehydrating coolant 100.

Glycol dehydrating coolant 100 flows into an inflow manifold 314 and is directed down under pumping pressure to the copper lance tip 306. There, it turns picking up heat and flows back up outside in a liquid cooling jacket 318 to an outflow manifold 320. The velocity and pressure of the heat transfer fluid mixture as it turns back up inside the metal lance tip 306 are critical. The intense heat from submerging the metal TSL tip 306 in the furnace bath can incite gas bubble formation and film boiling. Both can be opposed with high velocities for the heat transfer fluid. The specific heat and viscosity of the heat transfer fluid will determine the required velocity to prevent film boiling at a specific heat flux. The specific heat of the heat transfer fluid mixture will thus be prevented from degrading due to boil gases mixing in.

The down flowing and exiting oxygen and supplemental fuel assist in overall cooling of the copper lance tip 306.

TSL types of pyrometallurgical furnaces smelt non-ferrous metals from ore sulphides that will burn and self-generate heat with injected oxygen. Herein, we describe embodiments of the present invention that are applied as improvements to specific commercial products like the Glencore ISASMELT, Outotec AUSMELT, and other commercially marketed TSL furnaces as exemplars.

Top submerged lances present a particular challenge, addressed here, in that uneven cooling and the resulting heat excursions can cause them to both curve and to wear too fast. Typically, a portion of any material fed in above the bath will be lost into the off-gas stream.

Commercially available inhibited ethylene glycol-based heat transfer fluids are useful herein, and such already include corrosion inhibitors. These inhibitors prevent corrosion of metals in two ways. First, they passivate the metal surfaces, and react with them to prevent acids from attacking. A passivation process results that does not foul the internal heat transfer surfaces. Conventional inhibitors, in contrast, usually coat heat transfer surfaces with a thick silicate gel that gets in the way of good heat transfer. Second, the inhibitors buffer acids that form as a result of glycol oxidation. (All glycols produce organic acids as degradation products.) Such degradation will accelerate in the presence of oxygen and/or heat. If left in solution, such acids lower the pH and will contribute to corrosion. The formulated inhibitors neutralize such acids.

Water inside a pyrometallurgical furnace can be catastrophic in two ways. First it can be the liquid that explodes into steam to produce a BLEVE. And second, the refractory linings can be severely damaged if they absorb any water. It is therefore an object of the present invention to cool oxygen lances with liquids that cannot BLEVE, and with liquids that will not damage refractory.

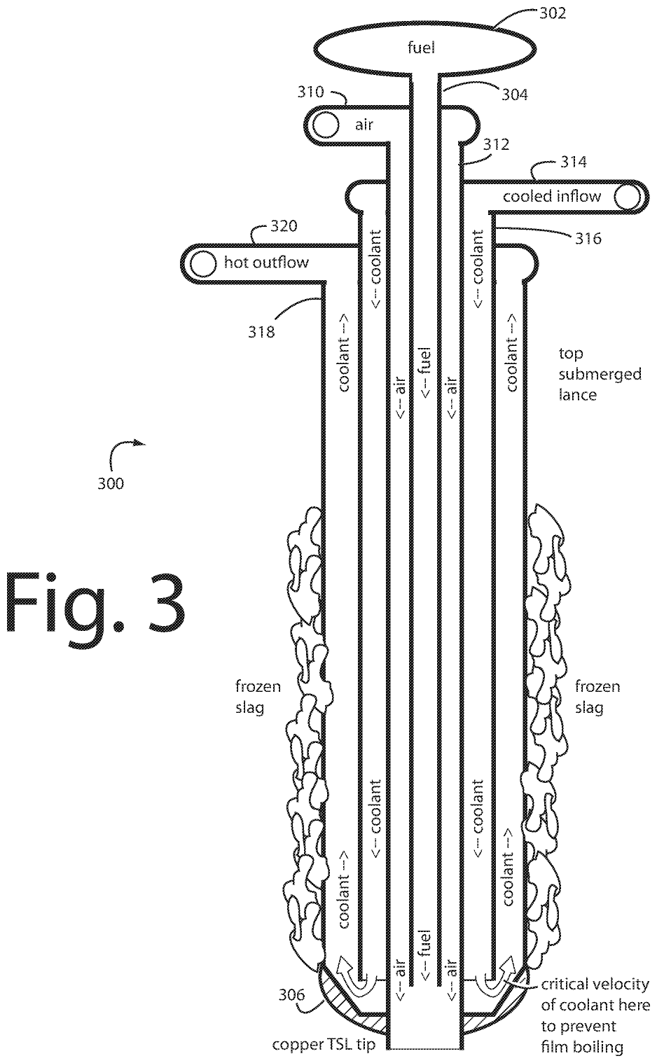

FIG. 4 represents the use of glycol dehydrating coolant 100 (FIG. 1) in a cooling system 400 for a pyrometallurgical furnace 402 equipped with coolers 404. The coolers 404 remove heat from a refractory brick lining supported on the hotface of each stave cooler 404. Each cooler 404 mounts inside a furnace shell 406. Such connection and support can be made to be gas-tight, meaning toxic process gases created inside pyrometallurgical furnace 402 are prevented from escaping through here.

Coolant pipe outlets carry hot glycol dehydrating coolant 100 through an expansion tank 410 to a heat exchanger 411 to dump waste heat. A pressure system 412 and desiccant containment 414 keep glycol dehydrating coolant 100 under a safe operating pressure. Glycol dehydrating coolant 100 can be tested, added to, or replaced. A filter 416 removes solid corrosion particles and scale before a pump 418 pushes glycol dehydrating coolant 100 into cooler 404. A minimum velocity 420 is required to avoid film boiling.

When using water, a velocity greater than 0.9 m/s is sufficient to flush out any bubbles or initial air in the pipes. A more common minimum is 2.0 m/s for most cooled components and 4.0 m/s at locations with high or greatly varying heat loads such as tapholes and landers.

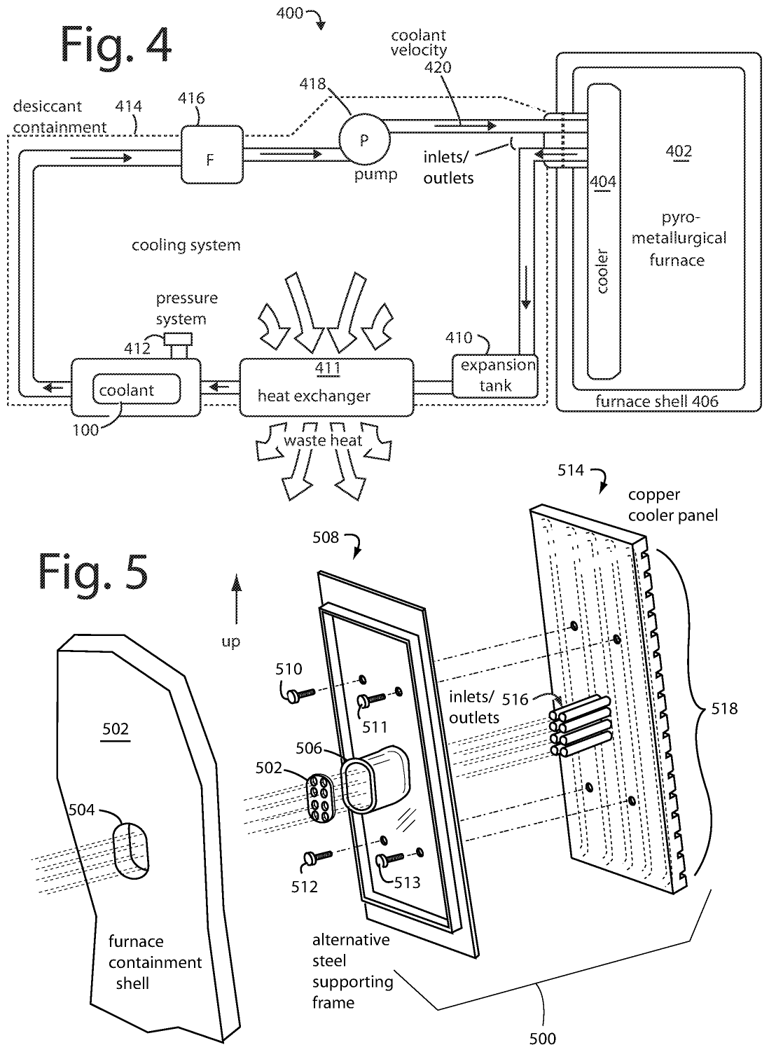

FIG. 5 is a stave cooler 500 in an embodiment of the present invention like stave cooler 404 (FIG. 4). The stave cooler 500 mounts inside a pyrometallurgical furnace containment shell 502 and hangs through a torch-cut hole 504. A steel coolant-pipe connection box 506 is passed through the torch-cut hole 504 and is welded to be gas-tight. Usually this is done with an accessory steel closure plate or ring.

The steel coolant-pipe connection box 506 is itself welded to a steel supporting frame 508. Generally, laterally in the middle, and off center close to the top. The steel supporting frame 508 attaches with fasteners 510-513 to a cast copper stave cooler panel 514. A group of coolant inlet and outlet pipe ends 516 protrudes from the backside and passes through the steel coolant-pipe connection box 506, a gas seal plate 518, and torch cut hole 504 to the outside. The group of coolant inlet and outlet pipe ends 516 and the cast-in coolant pipes within cast copper stave cooler panel 514 all together maintain their part of desiccant containment vessel 414 (FIG. 4).

The cast copper cooler panel 514 requires some wear protection, and this can be provided by ribs and grooves 518 that retain refractory bricks, cast iron inserts, hard face weld overlays, or castable cement.

The steel coolant-pipe connection box 506 can be attached directly to cast copper cooler panel 514 in many other ways not needing steel supporting frame 508. But steel supporting frame 508 allows the cast copper cooler panel 514 to be made thinner and lighter than would otherwise be the case.

The volume of cooling required for pyrometallurgical furnaces and associated equipment can be substantial. Leaks in the supply and return piping can develop outside the furnace from time to time. Many of these vessels must remain online for several years.

There is a widespread need for furnace cooling which is intrinsically safe, relatively low cost, commercially available in significant quantities, fast and easy to replace in case of a leak, very low environmental risk if there is a leak, well documented properties necessary for the design of the pumping and containment systems, and stable for long periods of continuous service.

The coolant embodiments of the present invention described herein satisfy such requirements.

Other furnace application embodiments of the present invention include rotary vessels (Noranda Reactor, El Teniente Converter, Anode Furnaces, Pierce Smith Converter, Hoboken Converter, Holding Furnaces), for cooling of mouths, tapholes, feed ports, off-gas ports, tuyeres, and porous plugs, as well as furnace off-gas systems (hoods, ducts, quench or spray cooled chambers).

The tuyeres and tapholes on a Noranda Reactor or El Teniente Converter can be exposed to the hot bath. If liquid cooling is employed, and there is a leak, the result could be an explosion. If the mouth is liquid cooled, it could leak into the vessel or when material is added (charged) in the furnace, or when material is poured out.

Liquid cooled hoods over a rotary furnace are exposed to hot gasses as well as possible splash from molten material. They normally contain a lot of cooling fluid as they are relatively large structures. Hence, a leak into the furnace could be catastrophic.

Although particular embodiments of the present invention have been described and illustrated, such is not intended to limit the invention. Modifications and changes will no doubt become apparent to those skilled in the art, and it is intended that the invention only be limited by the scope of the appended claims.

1. A glycol dehydrating coolant, comprising:
a blend for placing a solute of water in a solvent of glycol to produce a glycol dehydrating coolant in which initially every molecule of water is hydrogen-bound to a molecule of glycol, and there are a substantial excess of glycol molecules not hydrogen-bound and available for subsequent hydrogen-bounding if additional water is added later;
wherein, a total number of molecules of glycol exceeds a total number of molecules of water in the blend; and
wherein, any leakage of the glycol dehydrating coolant is intrinsically safe from steam explosions when circulated as a principal coolant in a pyrometallurgical furnace cooler.

2. The glycol dehydrating coolant of claim 1, wherein:
the glycol is ethylene glycol (MEG) with a molar mass of about 62.07 grams;
the blend initially comprises a minimum of about 62.07 grams of glycol for about every 18.02 grams of water such that every molecule of water will be hydrogen bound to a molecule of glycol.

3. The glycol dehydrating coolant of claim 2, further comprising:
a corrosion inhibitor of about 1390±200 grams-per-liter added to the blend, and that is insoluble with the water or the glycol, and in a proportion of 4%-Wt to 8%-Wt, and that does not interfere with each and every molecule of water being hydrogen-bound to its own molecule of glycol in an excess of glycol;
wherein, corrosion inside the pyrometallurgical furnace cooler is controlled without significant increases to the thermal resistance or losses in thermal conductivity.

4. The glycol dehydrating coolant of claim 3, wherein the weight percent of water in a combined coolant is about 22.5%-Wt without any corrosion inhibitors, and about 21%-Wt to 22%-Wt with corrosion inhibitors.

5. A glycol dehydrating coolant, comprising:
a glycol dehydrating coolant in which substantially all the molecules of any initial weight of water it includes have been physically absorbed by a hygroscopic action into an initial weight of glycol solvent that it also includes;
wherein, substantially all the molecules of the initial weight of water included are suspended between the molecules of a first portion of the initial weight of glycol solvent due to the hygroscopic action;
wherein, there remains a substantial second portion of the initial weight of glycol solvent available to physically absorb any other water or steam that may come in contact with the glycol dehydrating coolant that circulated as a coolant in a pyrometallurgical furnace; and
wherein, a hydrogen bonding of all water molecules between less than all the glycol solvent molecules prevents or substantially reduces a risk that the glycol dehydrating coolant will produce a steam explosion in the event any of it directly contacts any superheated materials within the pyrometallurgical furnace.

6. The glycol dehydrating coolant of claim 5, further comprising:
means for preventing the absorption of water or humidity from the environment into the glycol dehydrating coolant;
wherein, there is prevented an accumulation of molecules of water that would out number the total number of glycol molecules in the glycol dehydrating coolant.

7. The glycol dehydrating coolant of claim 5, further comprising:
means for desiccating free water or humidity immediately into the glycol dehydrating coolant.

8. A method of intrinsically safe operation of a liquid cooled pyrometallurgical furnace at reduced risk of boiling liquid expanding vapor explosion (BLEVE), comprising:
preparing an initial blend of glycol dehydrating coolant to include at least one molecule of glycol for every molecule of water; and
circulating the initial blend of glycol dehydrating coolant through pyrometallurgical furnace under pressure and contained so as not to be exposed to atmospheric moisture.

9. The method of claim 8, wherein the preparing is such that a glycol included is ethylene glycol (MEG) with a molar mass of about 62.07 grams and initially comprises a minimum of about 62.07 grams of glycol for about every 18.02 grams of water included such that every molecule of water will be hydrogen bound to a molecule of glycol.
